(19) United States
(12) Patent Application Publication
(10) Pub. No.: US 2008/0204470 A1
(43) Pub. Date: Aug. 28, 2008

(54) DISPLAY APPARATUS, IMAGE FORMING APPARATUS AND DISPLAY METHOD

(75) Inventor: Nobuyuki Kato, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/679,538

(22) Filed: Feb. 27, 2007

(51) Int. Cl. G09G 5/06

(52) U.S. Cl. 345/593

(57) ABSTRACT

A display apparatus according to the invention includes a display unit, an index-data storing unit, and a palette-table storing unit. The index-data storing unit stores data for different uses in different planes. The indexes, which can be divided into the data, indirectly indicate display colors that should be colored on pixels of the display unit. The palette-table storing unit stores a palette table. The palette table gives color data associated with the indexes. The color data directly indicating the display colors that should be colored on the pixels. And the palette table configured to be capable of selecting the color data according to the uses.

### BACKGROUND

1. Field

The present invention relates to a display apparatus that has a VRAM including a plurality of planes, an image forming apparatus, and a display method.

2. Description of the Related Art

Recently, color display apparatuses are used for operation panels of various apparatuses. Color display screens of the color display apparatuses have an advantage that the color display screens are excellent in ability of expression and have a high level of visibility compared with conventional monochrome display screens.

However, the color display apparatuses have to treat a large data quantity and require longer data processing time compared with monochrome display apparatuses. As a result, when the color display apparatuses are used as operation panels of various apparatuses, there is a disadvantage that speed of response to an instruction from a user falls and operability is deteriorated. Therefore, various techniques concerning reduction in this kind of data processing time have been conventionally proposed.

A CRT control circuit having a palette function disclosed in JP-B 06-31930 includes a video memory (hereinafter referred to as VRAM) having plural planes, palette table, and parallel to serial converter. By providing the parallel to serial converter in a post stage of the palette table, the palette table is directly accessed with parallel data with an N-bit configuration read out from each of the planes of the VRAM without converting the parallel data into serial data. Therefore, this CRT control circuit can delay a period of access to the palette table and it is possible to apply a low-speed element to the palette table.

A gray shade display control apparatus disclosed in JP-A 08-54609 is a gray shade display control apparatus that has a VRAM including two planes and is capable of displaying four tones. When binary (monochrome) display is performed, the gray shade display control apparatus can perform the binary display on the basis of only data of one plane by changing a tone register (a palette table).

A display apparatus disclosed in JP-A 04-97390 includes a VRAM of a packed pixel format and a plane-pack converting mechanism for converting a configuration of this VRAM viewed from a central processing unit into a planar format in appearance. The display apparatus can perform processing for writing data of the planar format in the VRAM of the packed pixel format at high speed.

These conventional techniques contrive a method of treatment of data read out from the VRAM and a method of treatment of data written in the VRAM to realize reduction in a data processing time. However, in these conventional techniques, a data holding method of the VRAM is not contrived. Therefore, when the palette function is used in these conventional techniques, it is necessary to change data of all the planes in order to change a display image.

This is because the plural planes dispersedly hold information with one palette number. It is necessary to change palette numbers of respective pixels in order to change the display image, i.e., change display colors of the respective pixels. However, information on palette numbers of the respective pixels is dispersedly held by the plural planes. Therefore, in changing the display colors of the respective pixels, it is necessary to change data of all the planes.

Therefore, as a problem of the conventional techniques, since it is necessary to change data of all the planes, even in a slight change such as a change of a part of a character image with an identical background image, time required for display change is long.

In particular, in the operation panels of the various apparatuses, complicated display of images is not required. Color display apparatuses used for these operation panels are often required to have only a function enough for making it possible to realize improvement of visibility by applying slight coloring to a binary display image such as a monochrome image conventionally used. Therefore, the color display apparatuses employing the conventional techniques have low efficiency, in particular, when simple images used for the operation panels are treated.

There is also a problem in that, when binary image data for the monochrome display apparatus conventionally used is converted into data for the color display apparatuses, since it is necessary to reconfigure data of all the planes, considerable time and labor are required.

### SUMMARY OF THE INVENTION

The present invention has been devised taking the circumstances into account, and accordingly it is an object of the present invention to provide a display apparatus, an image forming apparatus, and a display method that can easily perform high-speed image display change.

In order to attain the object, a display apparatus according to an aspect of the present invention includes a display unit; an index-data storing unit configured to store data for different uses in different planes, the data provided by dividing information on indexes by uses, the indexes indirectly indicating display colors that should be colored on pixels of the display unit; and a palette-table storing unit configured to store a palette table, the palette table giving color data associated with the indexes, the color data directly indicating the display colors that should be colored on the pixels, and the palette table configured to be capable of selecting the color data according to the uses.

Further, to attain the object, an image forming apparatus according to another aspect of the present invention includes a display unit; an index-data storing unit configured to store data for different uses in different planes, the data provided by dividing information on indexes by uses, the indexes indirectly indicating display colors that should be colored on pixels of the display unit; and a palette-table storing unit configured to store a palette table, the palette table giving color data associated with the indexes, the color data directly indicating the display colors that should be colored on the pixels, and the palette table configured to be capable of selecting the color data according to the uses.

Further more, to attain the object, a display method according to still another aspect of the present invention includes a step of dividing indexes into data by uses, the indexes indirectly indicating display colors that should be colored on pixels of a display unit; storing the data for the different uses in different planes; and storing a palette table, the palette table giving color data associated with the indexes, the color data directly indicating the display colors that should be colored on the pixels, and the palette table configured to be capable of selecting the color data according to the uses.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram showing an example of a display apparatus and an image forming apparatus including the display apparatus according to a first embodiment of the present invention;

FIG. 2 is an explanatory diagram showing a relation between data stored in respective planes of a VRAM and display colors of respective pixels;

FIG. 3 is an explanatory diagram showing an example of a virtual address space of a CPU in the case where the number of pixels of a display unit is 640 pixels×240 rows=153600 pixels;

FIG. 4 is an explanatory diagram showing an example of an image of a soft key (button) displayed on a conventional binary (monochrome) display unit;

FIG. 5 is an explanatory diagram showing an example of an image obtained by applying coloring to a binary display image shown in FIG. 4;

FIG. 6 is an explanatory diagram showing an image obtained by replacing color areas with hatching in the image shown in FIG. 5;

FIGS. 7A to 7D are explanatory diagrams schematically showing the data of the respective planes of the VRAM shown in FIG. 2 in the case where the image shown in FIG. 6 is displayed;

FIG. 8 is an explanatory diagram showing an example of a palette table giving color data associated with indexes (palette numbers) in the case in which the image shown in FIG. 6 is displayed;

FIG. 9 is an explanatory diagram briefly showing the palette table shown in FIG. 8 by putting redundant data in order;

FIG. 10 is an explanatory diagram showing an example of a binary display image (table) displayed on the conventional binary (monochrome) display unit;

FIG. 11 is an explanatory diagram showing an example of an image obtained by applying coloring to the binary display image shown in FIG. 10;

FIG. 12 is an explanatory diagram showing an image obtained by replacing color areas with hatching in the image of the table shown in FIG. 11;

FIGS. 13A to 13D are explanatory diagrams schematically showing data of the respective planes of the VRAM in the case where the image shown in FIG. 12 is displayed;

FIG. 14 is a diagram showing an example of a state of an operation panel in which the image shown in FIG. 12 is displayed on a display unit of a display-input unit of the operation panel; and

FIG. 15 is a diagram showing an example of a state of the operation panel in which a software keyboard is displayed on the display unit of the display-input unit of the operation panel.

### DETAILED DESCRIPTION

Hereinbelow, a description will be given of a display apparatus, an image forming apparatus, and a display method, according to an embodiment of the present invention with reference to the drawings.

### (1) First Embodiment

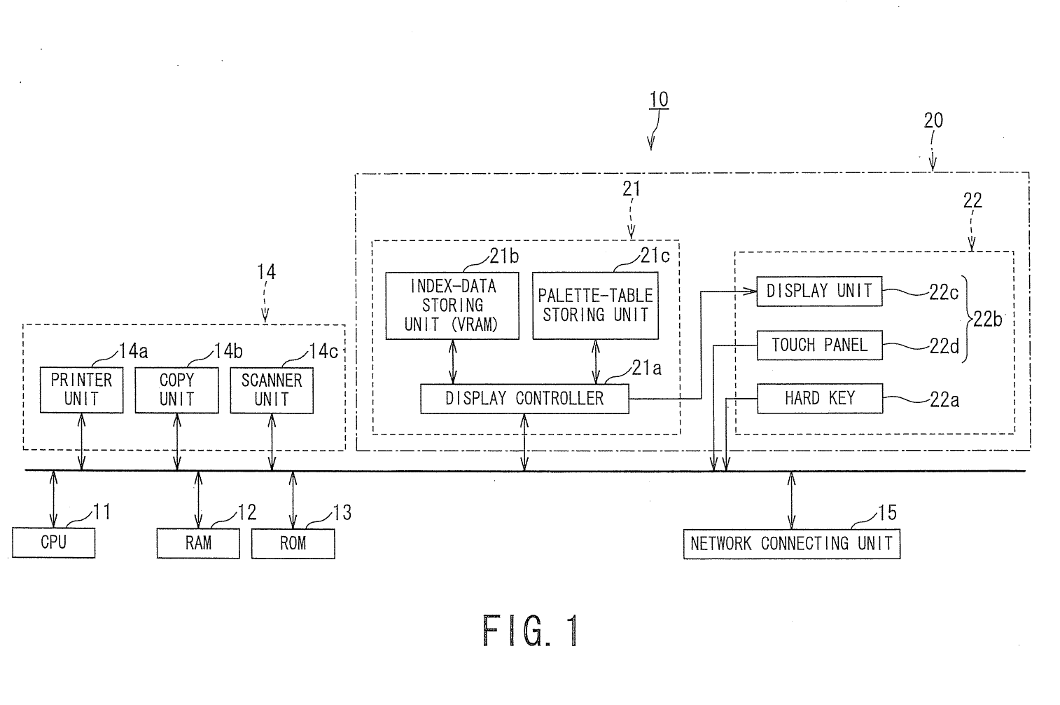

FIG. 1 is a schematic block diagram showing an example of a display apparatus and an image forming apparatus including the display apparatus according to a first embodiment of the present invention.

Note that with the present embodiment, a multi function peripheral having a copy function, a printer function, a scanner function, and the like, will be used as an example of an image forming apparatus.

The image forming apparatus 10 includes a CPU 11, RAM 12, ROM 13, JOB executing unit 14, network connecting unit 15, and display apparatus 20.

The CPU 11 controls operations of the image forming apparatus 10 in accordance with programs stored in the ROM 13. The CPU 11 loads various programs stored in the ROM 13 and data necessary for execution of the programs to the RAM 12 and executes processing for controlling the entire image forming apparatus 10 including the display apparatus 20 in accordance with the various programs.

The RAM 12 provides a work area for temporarily storing the data and the programs executed by the CPU 11.

The ROM 13 stores the various programs such as a startup program for the image forming apparatus 10 and the various data necessary for executing these programs. The ROM 13 also stores plural palette tables and image data to be displayed on a display unit 22c of the display apparatus 20.

Note that the ROM 13 has a configuration including a storage medium which is readable by the CPU 11, such as magnetic or optical storage medium or semiconductor memory or the like, and may be configured so as to download a part or all of the programs and the data within the ROM 13 via an electronic network.

The JOB executing unit 14 realizes various functions of a printer, a copier, a scanner, a facsimile, and the like of the image forming apparatus 10. In FIG. 1, an example of a structure of the JOB executing unit 14 is schematically shown, in the case in which the image forming apparatus 10 has the functions of a printer, a copier, and a scanner and the functions are realized by a printer unit 14a, a copy unit 14b, and a scanner unit 14c, respectively.

The network connecting unit 15 is implemented with various protocols for information communication corresponding to forms of networks. The network connecting unit 15 connects the image forming apparatus 10 and other electric apparatuses in accordance with the various protocols. It is possible to apply electric connection or the like through the electronic network to this connection. Note that the electronic network includes an information communication network in general that employs an electric communication technique. The electronic network includes, other than a LAN (Local Area Network) and the Internet, a telephone communication line network, an optical fiber communication network, a cable communication network, and a satellite communication network.

The display apparatus 20 includes a display control unit 21 and an operation panel 22.

The display control unit 21 includes a display controller 21a, a VRAM 21b (a video memory) as an index-data storing unit that stores indexes (palette numbers) indirectly indicating display colors that should be colored on pixels of the display unit 22c, and a palette-table storing unit 21c that stores a palette table configured by associating color data directly indicating the display colors that should be colored on the display unit 22c with palette numbers.

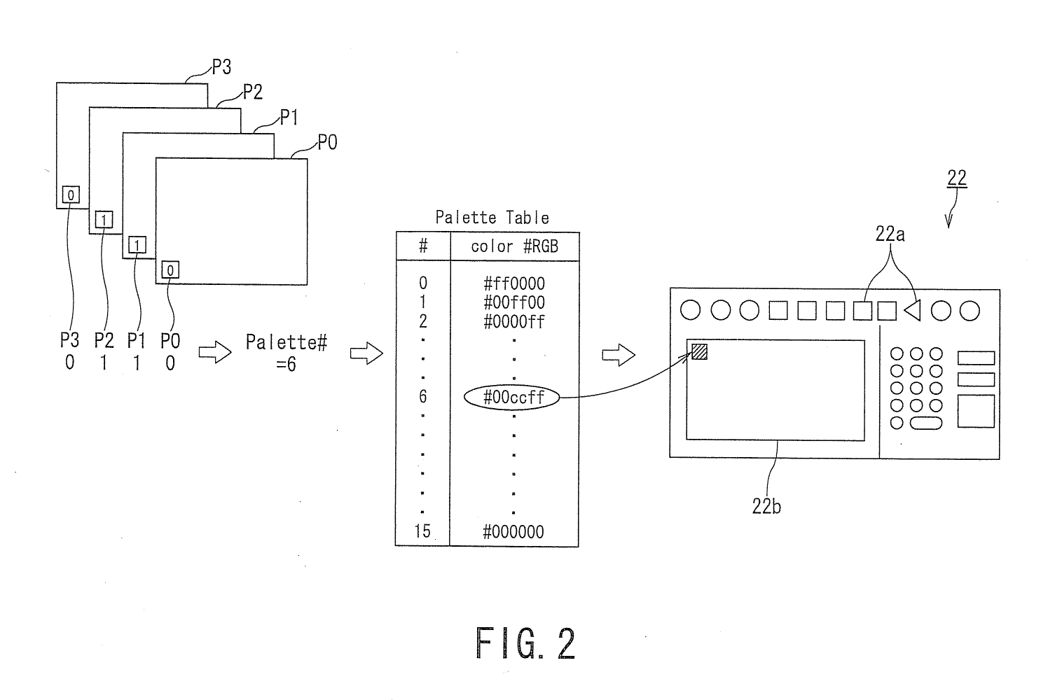

FIG. 2 is an explanatory diagram showing a relation between data stored in respective planes of the VRAM 21b and display colors of respective pixels. In this embodiment, a case in which the VRAM 21b includes four planes P0, P1, P2, and P3 will be explained.

The display controller 21a has a function of transferring data received from the CPU 11 to the VRAM 21b, of reading out data stored by the VRAM 21b, controlling a video signal on the basis of this data, and performing coloring for each of pixels to perform rendering (display of characters and figures) on the entire display unit 22c.

A procedure for performing display on the display unit 22c with the display control unit 21 is briefly explained as follows. First, the display controller 21a reads the data stored in the VRAM 21b and acquires a palette number as shown in FIG. 2 on the basis of this data. The display controller 21a searches through a palette table stored in the palette-table storing unit 21c in advance to acquire color data associated with this palette number and performs coloring of pixels on the basis of this color data. By applying this series of processing to all the pixels of the display unit 22c, the display controller 21a performs rendering of the entire display unit 22c.

The VRAM 21b includes plural planes. In general, the respective planes dispersedly hold information on palette numbers of the pixels. The respective planes may hold plural bits of data, into which the information on the palette numbers (indexes) of the pixels are divided (hereinafter referred to as divided palette numbers), for each of the pixels. In a case explained this embodiment, the respective planes hold the divided palette numbers, one bit for each of the pixels.

For example, as shown in FIG. 2, when there are four planes, it is possible to hold data of four bits in total for each of the pixels. This means that it is possible to use sixteen palette numbers. The number of usable palette numbers is determined according to the number of planes.

This VRAM 21b stores one of the image data stored in the ROM 13 when the image data is written in the VRAM 21b by the CPU 11 via the display controller 21a.

This image data stored in the ROM 13 is a set of palette numbers, corresponding to color data of the respective pixels, for all the pixels in the display unit 22c. The palette numbers of the respective pixels are stored in the ROM 13 as the divided palette numbers in association with the planes of the VRAM 21b. As shown in FIG. 2, the display controller 21a reads out the divided palette numbers corresponding to each of the pixels from the respective planes and unites the divided palette numbers to obtain the palette number corresponding to each of the pixels.

The palette-table storing unit 21c stores one of plural palette tables stored in the ROM 13 when the palette table is written in the palette-table storing unit 21c by the CPU 11 via the display controller 21a.

The palette table includes, as shown in FIG. 2, palette numbers and color data associated with the palette numbers. It is possible to set a data width of this color data to, for example, 3 bytes by allocating 1 byte (8 bits) to each of R, G, and B. In this case, colors that can be used for the color data are 256 kinds for each of R, G, and B, 16,777,216 colors in total. When the number of palette numbers is 16 (four planes can be used), sixteen colors appropriately selected from the 16,777,216 colors are associated with the respective palette numbers to form a palette table. It is possible to display a large number of colors with a limited number of planes by selecting one of the palette tables stored in the ROM 13 as required and using the appropriate palette table.

In this embodiment, in order to perform higher speed image display change, the palette numbers forming the image data stored in the ROM 13 shown in FIG. 1 are dispersed by uses in advance. The image data is written in the VRAM 21b such that divided palette numbers for different uses are stored in different planes. As a result, roles are given to the respective planes of the VRAM 21b by the uses.

For example, when a part of the image data is data for binary display (characters, dither patterns, etc.), one plane takes a role of holding divided palette numbers necessary for this binary display. When a part of the image data is data for quaternary display (coloring of areas separately with four colors, etc.), since a data volume required by the data for quaternary display is 2 bits, two planes take a role of holding divided palette numbers necessary for the quaternary display.

Since roles are given to the respective planes of the VRAM 21b by uses and divided palette numbers for different uses are stored in the planes, when a dispersed palette number is changed for each of the uses, it is unnecessary to change the planes for the other uses. As a result, compared with the conventional technique in which it is necessary to rewrite all the planes, efficiency is improved and it is possible to perform high-speed image display change.

In order to change image data by uses and reflect this change on colors of the pixels of the display unit 22c, contrivance is also necessary for a structure of the palette table. In order to reflect a change of data for each use on colors of the pixels of the display unit 22c, the palette table needs to be configured such that color data can be selected according to the uses.

As one of methods of constituting the palette table to make it possible to select color data by uses, a method of using a part of image data as data for identification (hereinafter referred to as “for mask”) for distinguishing the uses is conceivable. For example, a case in which 2 bits of image data (palette numbers) of the respective pixels are used for mask and two planes are used as planes for mask is considered. In this case, it is possible to identify four uses at the maximum by associating values of four kinds of data that can be held by the two planes for mask with the uses. It is possible to select color data of the respective pixels by uses, by constituting the palette table stored in the ROM 13 such that required color data is arranged for each of uses corresponding to values of data of the planes for mask.

The VRAM 21b and the palette-table storing unit 21c are mapped to a virtual address space. For example, when the CPU 11 writes data in the virtual addresses associated with the VRAM 21b or the palette-table storing unit 21c on the basis of the image data or the palette table stored in the ROM 13 respectively, the image data is written in the real addresses of the VRAM 21b or the palette table is written in the real addresses of the palette-table storing unit 21c, via the display controller 21a.

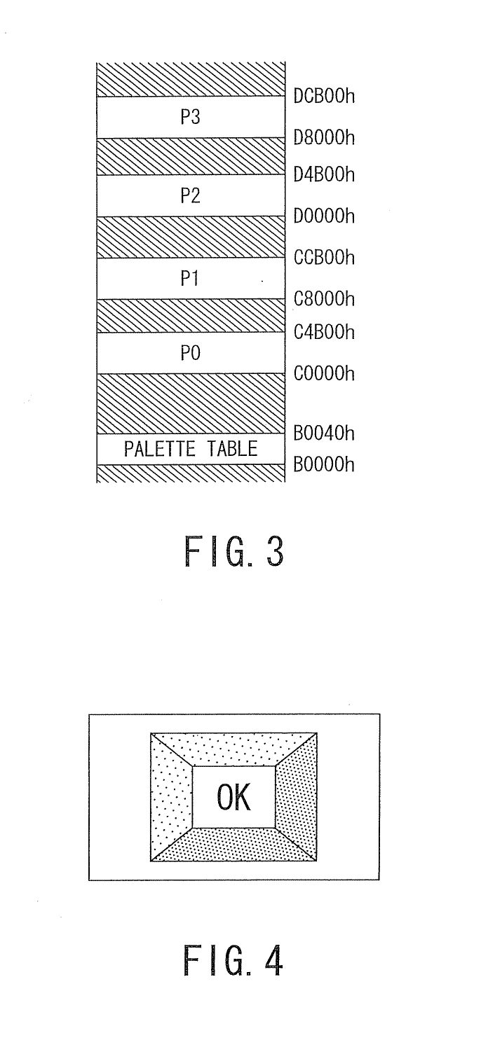

FIG. 3 is an explanatory diagram showing an example of the virtual address space of the CPU 11 in the case where the number of pixels of the display unit 22c is 640 pixels×240 rows=153600 pixels. The respective planes are allocated with data of 1 bit for one pixel. Therefore, when the number of pixels of the display unit 22c is 640 pixels×240 rows=153600 pixels, image data of the entire display unit 22c is 153600 bits=19200 bytes=4B0h bytes for each of the planes. Here, h is a code indicating hexadecimal notation. Hatching parts in FIG. 3 are blank addresses provided for convenience of explanation. The blanks do not have to be provided.

Data of the respective planes are arranged in memory spaces in a required form on the basis of an arrangement of the pixels of the display unit 22c. As this form, for example, there is a form in which, in order from the top of the memory spaces corresponding to the respective plans, data corresponding to the respective pixels are written from a pixel at the upper left end of the display unit 22c to a pixel on the right for the display unit 22c, next to data of a pixel at the right upper end of the display unit 22c, data of a pixel at the left end on a second row is written, and, lastly, data of a pixel at the right lower end is written. In this case, the display controller 21a can obtain a palette number of the pixel at the left upper end of the display unit 22c by acquiring data at the top of the respective planes (see FIG. 2). By sequentially reading the data of the respective planes from the top, the display controller 21a can acquire data (palette numbers) necessary for image display of the entire display unit 22c.

The operation panel 22 has hard keys 22a such as buttons, which give instruction signals peculiar thereto to the CPU 11 when a user presses the hard keys 22a, and a display-input unit 22b.

The display-input unit 22b has the display unit 22c and a touch panel 22d provided near the display unit 22c.

The display unit 22c displays an image received from the display controller 21a. This image is a set of color data of respective pixels. The display unit 22c is controlled by the CPU 11 to display information for operating the image forming apparatus 10 and plural keys (hereinafter referred to as soft keys) for operating the image forming apparatus 10. The touch panel 22d gives information on a position on the touch panel 22d pointed by the user to the CPU 11 of the image forming apparatus 10. As this display unit 22c, it is possible to use, for example, an LCD or an OLED (Organic Light Emitting Diode) display . . .

For example, when the user intends to perform operation for pressing one of the soft keys displayed on the display unit 22c, the user attempts to touch a corresponding part of this soft key on the screen. The touch panel 22d acquires information obtained from this touch operation. In the case of applying an optical touch panel of an infrared ray shielding system as the touch panel 22d, the touch panel 22d acquires information on a position where an infrared ray is shielded as the information on the position pointed by the user, and gives the information to the CPU 11 of the image forming apparatus 10. It is advisable to install this operation panel 22 in a position where the user can easily operate the operation panel 22.

An example of operations of the image forming apparatus 10 (including operations of the display apparatus 20) according to this embodiment will be explained.

First, the conventional binary display image and an image obtained by applying coloring to this image will be briefly explained.

FIG. 4 is an explanatory diagram showing an example of an image (a binary display image) of a soft key (button) displayed on the conventional binary (monochrome) display unit 22c (an LCD, etc.). As shown in FIG. 4, the binary display image includes only information on whether respective pixels are colored (presence or absence of dots).

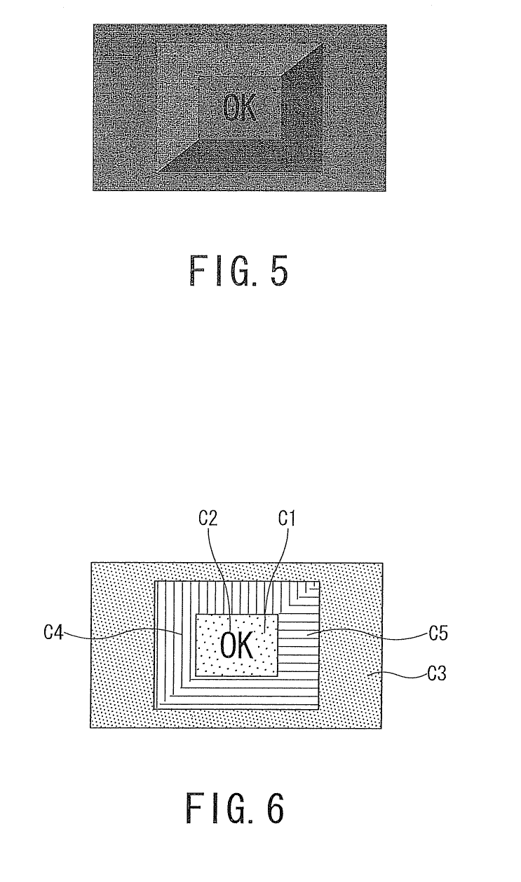

FIG. 5 is an explanatory diagram showing an example of the image obtained by applying coloring to the binary display image shown in FIG. 4. A function of an image of a button shown in FIG. 5 as a soft key is completely identical with a function of the binary display image of the button shown in FIG. 4 as a soft key. As shown in FIG. 5, it is possible to represent a natural three-dimensional effect by applying coloring to the binary display image.

FIG. 6 is an explanatory diagram showing an image obtained by replacing colored areas with hatching in the image of the button shown in FIG. 5. The image shown in FIG. 6 is completely identical with the image shown in FIG. 5 except that the identical colors are changed to identical hatching for convenience of explanation. In FIG. 6, C1 to C5 represents colors, respectively.

An example of the VRAM 21b shown in FIG. 1 and the palette table will be explained.

In this embodiment, as shown in FIG. 2, as an example in which divided palette numbers for different uses are stored in different planes when there are four planes (when it is possible to hold data of 4 bits in total for each of pixels), an example in which one plane is set as a plane for mask, one plane is set as data for binary display, and the remaining two planes are set as planes for color display will be explained.

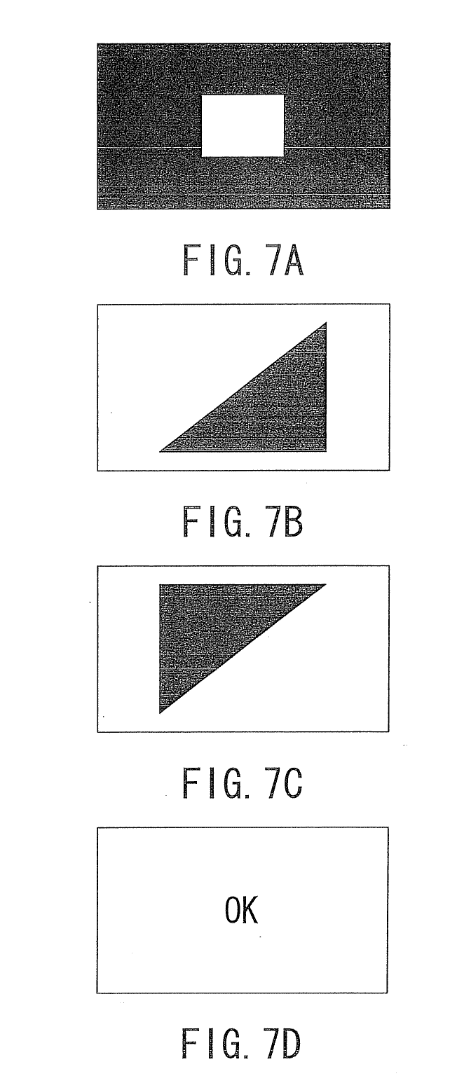

FIGS. 7A to 7D are explanatory diagrams schematically showing the data of the respective planes of the VRAM 21b shown in FIG. 2 in the case where the image shown in FIG. 6 is displayed. FIG. 7A shows a data of the plane P3 in which data for mask is stored, FIGS. 7B and 7C show data of the planes P2 and P1 in which data for color display are stored, and FIG. 7D shows data of the plane P0 in which data for binary display is stored.

In FIGS. 7A to 7D, zero is written in a white area. 1 is written in a black area in the respective planes. The display controller 21a reads divided palette numbers stored in the respective planes and aggregates the divided palette numbers to acquire a palette number.

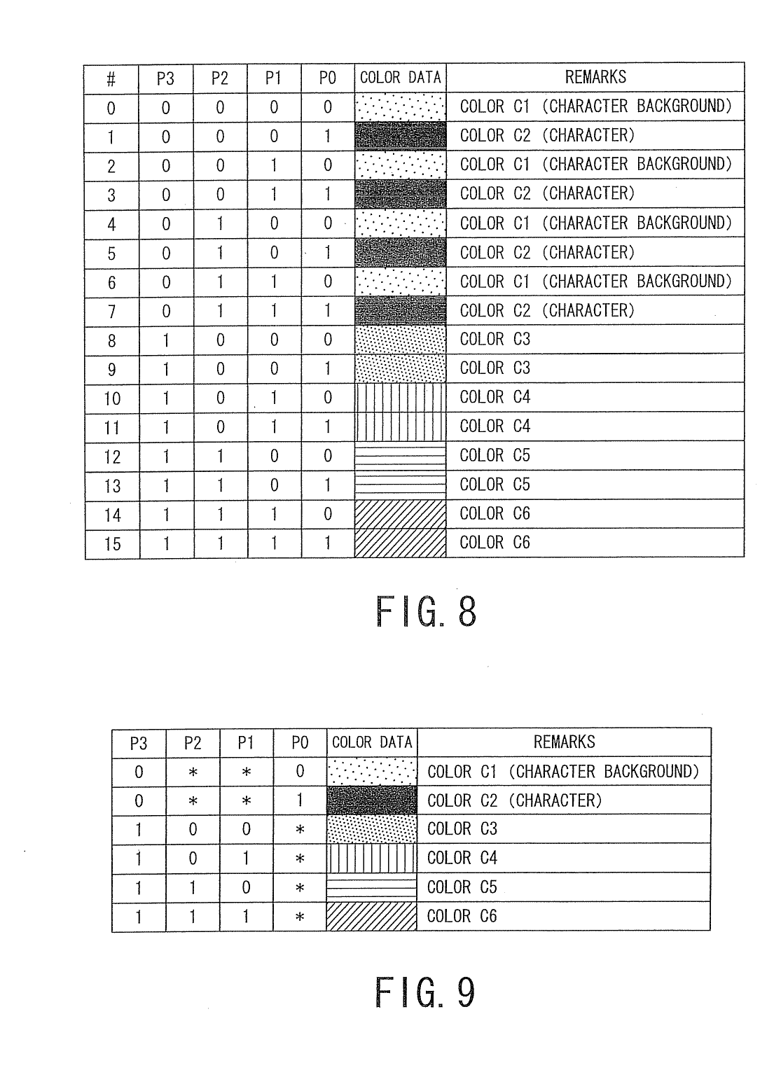

FIG. 8 is an explanatory diagram showing an example of a palette table giving color data associated with a palette number (index) obtained by uniting data of the respective planes in FIGS. 7A to 7D when the image shown in FIG. 6 is displayed.

FIG. 9 is an explanatory diagram briefly showing the palette table shown in FIG. 8 by putting redundant data in order. In FIG. 9, “*” is a sign indicating that data may be either 0 or 1.

As shown in FIGS. 8 and 9, the palette table is constituted to make it possible to select color data by the uses. The color data of the palette table includes two kinds of color data for binary display (a color C1 and a color C2) and four kinds of color data for color display (colors C3 to C6). As shown in FIG. 9, when a value of the palette P3 is zero, regardless of values of the plane P1 and P2, one of the two kinds of color data for binary display is selected on the basis of only a value of the plane P0 for character display. When a value of the palette P3 is 1, regardless of a value of the plane P0, one of the four kinds of color data for color display is selected on the basis of only values of planes P1 and P2 for color display.

For example, in pixels near the center of the display unit 22c, a value of the plane P3 for mask shown in FIG. 7A is zero. Therefore, regardless of values of the planes P2 and P1 shown in FIGS. 7B and 7C, a pixel for which a value of the plane P0 shown in FIG. 7D is zero is colored by the color C1 (a character background) and a pixel for which a value of the plane P0 is 1 is colored by the color C2 (characters).

Therefore, for example, when characters on a key top portion of the image of the button shown in FIG. 6 is changed, the plane P0 only has to be changed and it is unnecessary to change the other planes.

It should be noted that, in order to constitute the palette table to make it possible to select color data according to a use, identical color data may be associated with plural palette numbers.

The number of palette numbers that can be given to respective uses by the plane for mask is a value obtained by dividing a total number of palette numbers by the number of uses identifiable by the plane for mask. When a VRAM includes four planes (a total number of palette numbers is sixteen) and there is one plane for mask (two kinds of identifiable uses), the number of palette numbers that can be given to each of the uses by the plane for mask is eight.

Two kinds of color data are necessary for binary display. Therefore, eight palette numbers allocated for binary display are allocated to the two kinds of color data according to a value of the plane for binary display (see a row of zero for P3 in FIG. 9).

Since plane for color display are two planes P1 and P2, there are four kinds of data that can be represented by the two planes (2 bits). Therefore, the eight palette numbers allocated for color display are allocated to four kinds of color data according to values of the planes for color display (see a row of 1 for P3 in FIG. 9).

The display apparatus 20 and the image forming apparatus 10 including this display apparatus 20 include the VRAM 21b in which divided palette numbers for different uses are stored in different planes and the palette table constituted to make it possible to select color data of respective pixels by uses. Therefore, it is possible to change image data by uses without affecting planes related to other uses and reflect this change on colors of the pixels of the display unit 22c. Therefore, according to the display apparatus 20 and the image forming apparatus 10 including this display apparatus 20 according to this embodiment, it is possible to perform display change for an image extremely easily, efficiently, and at high speed.

Also, the display apparatus 20 and the image forming apparatus 10 including this display apparatus 20 according to this embodiment can effectively use the conventional binary display image. Therefore, it is possible to save time and labor in converting image data into image data for a color display apparatus.

### (2) Second Embodiment

A second embodiment of the display apparatus and the image forming apparatus including the display apparatus according to the invention will be explained.

A display apparatus 20A and an image forming apparatus 10A including the display apparatus 20A described in this second embodiment is different from the display apparatus 20 and the image forming apparatus 10 including the display apparatus 20 described in the first embodiment, only in image data stored in the ROM 13. Since the other components and actions are not substantially different from those of the display apparatus 20 and the image forming apparatus 10 including the display apparatus 20 shown in FIG. 1, the same components are denoted by the identical reference numerals and signs, and explanations of the components are omitted.

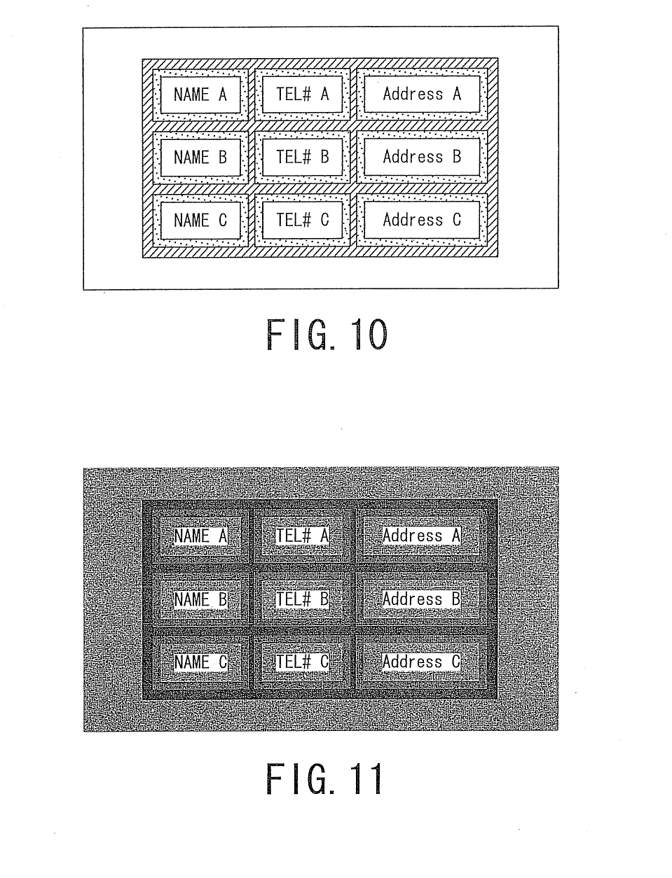

FIG. 10 is an explanatory diagram showing an example of a binary display image (table) displayed on the conventional binary (monochrome) display unit 22c (an LCD, etc.). The table shows a part of an address book, including names (NAME), telephone numbers (TEL#), and addresses (Address). In this embodiment, a case in which this address book includes information of names (NAME), telephone numbers (TEL#), and addresses (Address) of four or more people, and a size of the table is a size enough for displaying information of three people simultaneously will be explained.

FIG. 11 is an explanatory diagram showing an example of an image obtained by applying coloring to the binary display image shown in FIG. 10. Information such as names provided by an image of a table shown in FIG. 11 is completely identical with the binary display image of the table shown in FIG. 10.

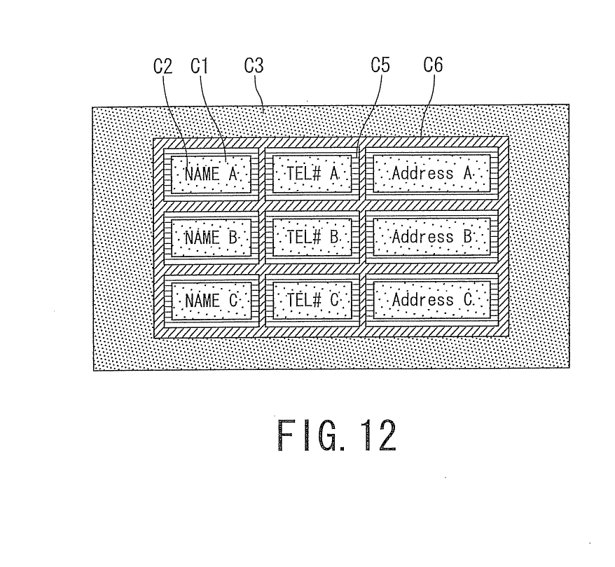

FIG. 12 is an explanatory diagram showing an image obtained by replacing colored areas with hatching in the image of the table shown in FIG. 11. The image shown in FIG. 12 is completely the same as the image shown in FIG. 11 except that the identical colors are changed to identical hatching for convenience of explanation. In FIG. 12, C1, C2, C3, C5, and C6 represent colors, respectively.

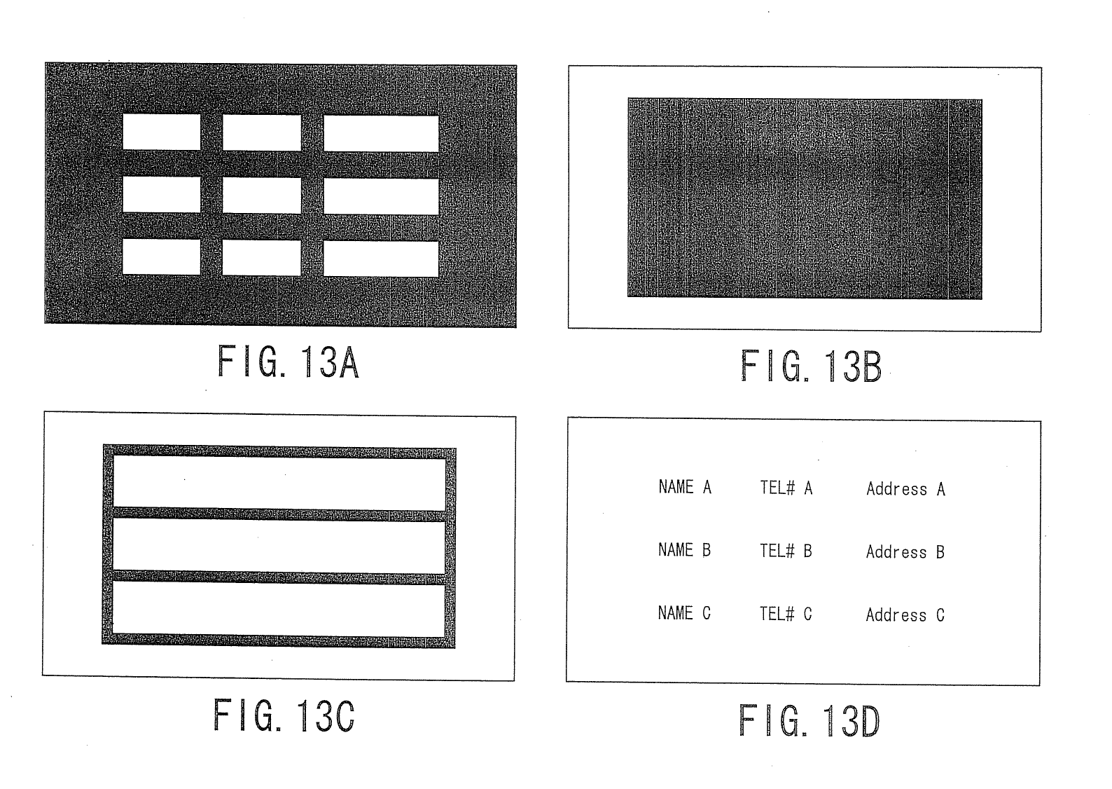

FIGS. 13A to 13D are explanatory diagrams schematically showing data of the respective planes of the VRAM 21b in the case where the image shown in FIG. 12 is displayed. FIG. 13A shows data of the plane P3 in which data for mask is stored, FIGS. 13B and 13C show data of the planes P2 and P1 in which data for color display are stored, and FIG. 13D shows data of the plane P0 in which data for binary display is stored.

In FIGS. 13A to 13D, zero is written in white areas and 1 is written in black areas in the respective planes.

It is possible to use a palette table completely identical with the palette table in the first embodiment shown in FIGS. 8 and 9.

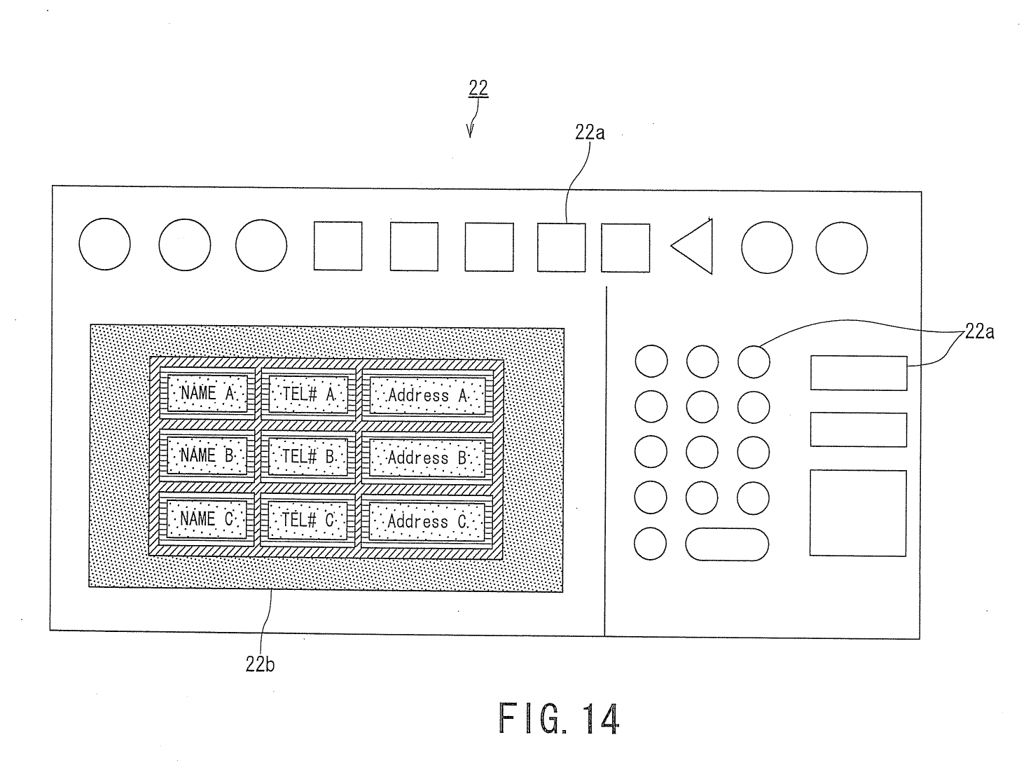

FIG. 14 is a diagram showing an example of a state of the operation panel 22 in which the image (table) shown in FIG. 12 is on the display unit 22c of the display-input unit 22b of the operation panel.

When desired information is not present in information displayed in this table, it is conceivable that the user desires to change (scroll) contents of this table row by row or change all the contents of the table (change a page).

In this case, it is unnecessary to rewrite all images displayed. Only information of characters in the images has to be changed. In order to change only the information of characters, only a value of the plane P0 for binary display shown in FIG. 13D has to be changed. By changing only a value of the plane P0, it is possible to change only character information without changing ruled line parts. When only the character information is changed, the user recognizes that the contents of the table are changed (scrolled) row by row or all the contents of the table is changed (a page is changed).

According to the display apparatus 20A and the image forming apparatus 10A including the display apparatus 20A according to this embodiment, it is possible to minimize a quantity of change in the data in scrolling the contents of the table or performing page change. Thus, compared with the conventional technique, it is possible to perform extremely high-speed scroll display and page change display. Therefore, it is possible to substantially reduce time required for changing display contents and improve convenience for the user.

With the display apparatus 20A and the image forming apparatus 10A including the display apparatus 20A according to this embodiment, it is possible to realize operations and effects same as those realized by the display apparatus 20 and the image forming apparatus 10 including the display apparatus 20 according to the first embodiment.

### (3) Third Embodiment

A third embodiment of the display apparatus and the image forming apparatus including the display apparatus according to the invention will be explained.

A display apparatus 20B and an image forming apparatus 10B including the display apparatus 20B are different from the display apparatus 20 and the image forming apparatus 10 including the display apparatus 20 described in the first embodiment, only in image data stored in the ROM 13. Since the other components and actions are not substantially different from those of the display apparatus 20 and the image forming apparatus 10 including the display apparatus 20 shown in FIG. 1, the same components are denoted by the identical reference numerals and signs and explanations of the components are omitted.

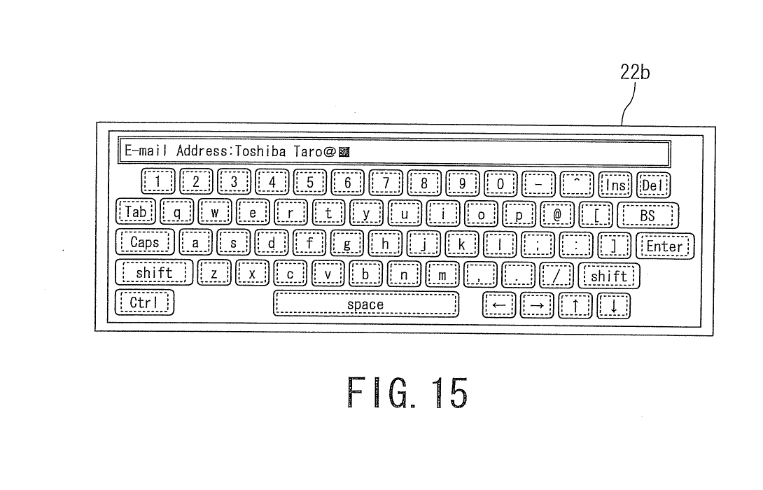

FIG. 15 is a diagram showing an example of a state of the operation panel in which a software keyboard is displayed on the display unit 22c of the display-input unit 22b.

As shown in FIG. 15, the software keyboard includes plural soft keys. For example, a case of a setting for changing all alphabet keys to capital letters when the user presses a “shift” key in the software keyboard shown in FIG. 15 will be considered. In the case of this setting, when the user presses the “shift” key, it is necessary to change key top portions of at least twenty-six soft keys.

According to the display apparatus 20B and the image forming apparatus 10B including the display apparatus 20B according to this embodiment, in changing the key top portions of the software keyboard, the plane P0 only has to be changed and it is unnecessary to change the other planes. Therefore, with the display apparatus 20B and the image forming apparatus 10B including the display apparatus 20B according to this embodiment, it is possible to efficiently perform high-speed image display change in the same manner as the display apparatus 20 and the image forming apparatus 10 including the display apparatus 20 according to the first embodiment.

The invention is not limited to the embodiments per se. It is possible to modify and embody the elements in a range not departing from the spirit of the invention at an implementation stage.

For example, the planes of the VRAM 21b only have to be constituted such that divided palette numbers for different uses are stored in different planes. The palette table only has to be constituted such that color data of respective pixels can be selected by the uses. Therefore, the number of planes constituting the VRAM 21b is not limited to four. The number of planes for mask is not limited to one.

It is possible to form inventions of various forms according to appropriate combinations of the plural elements disclosed in the embodiments. For example, several elements may be deleted from all the elements described in the embodiments. Further, the components according to the different embodiments may be properly combined.

What is claimed is:

1. A display apparatus comprising:
a display unit;
an index-data storing unit configured to store data for different uses in different planes, the data provided by dividing information on indexes by uses, the indexes indirectly indicating display colors that should be colored on pixels of the display unit; and
a palette-table storing unit configured to store a palette table, the palette table giving color data associated with the indexes, the color data directly indicating the display colors that should be colored on the pixels, and the palette table configured to be capable of selecting the color data according to the uses.

2. A display apparatus according to claim 1, wherein
one of the data is the data for identification, having a use for identifying the respective uses, and
the palette table is configured to be capable of selecting the color data according to a value of the data for identification, the color data related to one of the uses excluding the use for identifying the respective uses.

3. A display apparatus according to claim 1, wherein the planes are configured to store data by one bit, respectively.

4. A display apparatus according to claim 3, wherein
the index-data storing unit is configured such that one plane of the planes stores data for identification having a use for identifying the respective uses, another plane stores data for binary display, and the other planes store data for color display, and
the palette table is configured to be capable of selecting one of the color data for the binary display and the color data for the color display, according to a value of the data for identification.

5. A display apparatus according to claim 4, wherein
the index-data storing unit includes four planes, and
two of the planes store the data for the color display.

6. A display apparatus according to claim 1, wherein the index-data storing unit is a video memory.

7. A display apparatus according to claim 1, wherein the display unit is an LCD.

8. An image forming apparatus comprising:
a display unit;
an index-data storing unit configured to store data for different uses in different planes, the data provided by dividing information on indexes by uses, the indexes indirectly indicating display colors that should be colored on pixels of the display unit; and
a palette-table storing unit configured to store a palette table, the palette table giving color data associated with the indexes, the color data directly indicating the display colors that should be colored on the pixels, and the palette table configured to be capable of selecting the color data according to the uses.

9. An image forming apparatus according to claim 8, wherein
at least one of the data is the data for identification, having a use for identifying the respective uses, and
the palette table is configured to be capable of selecting the color data according to a value of the data for identification, the color data related to one of the uses excluding the use for identifying the respective uses.

10. An image forming apparatus according to claim 8, wherein the planes are configured to store data by one bit, respectively.

11. An image forming apparatus according to claim 10, wherein
the index-data storing unit is configured such that one plane of the planes stores data for identification having a use for identifying the respective uses, another plane stores data for binary display, and the other planes store data for color display, and
the palette table is configured to be capable of selecting one of the color data for the binary display and the color data for the color display, according to a value of the data for identification.

12. An image forming apparatus according to claim 11, wherein
the index-data storing unit includes four planes, and
there are two planes storing the data for the color display.

13. An image forming apparatus according to claim 8, wherein the index-data storing unit is a video memory.

14. An image forming apparatus according to claim 8, wherein the display unit is an LCD.

15. A display method comprising the steps of:
dividing indexes into data by uses, the indexes indirectly indicating display colors that should be colored on pixels of a display unit;
storing the data for the different uses in different planes; and
storing a palette table, the palette table giving color data associated with the indexes, the color data directly indicating the display colors that should be colored on the pixels, and the palette table configured to be capable of selecting the color data according to the uses.

16. A display method according to claim 15, wherein
one of the data is the data for identification, having a use for identifying the respective uses, and
the palette table is configured to be capable of selecting the color data according to a value of the data for identification, the color data related to one of the uses excluding the use for identifying the respective uses.

17. A display method according to claim 15, wherein the planes are configured to store data by one bit, respectively.

18. A display method according to claim 17, wherein
the step of storing the data in the planes stores data for identification having a use for identifying the respective uses in one plane of the planes, storing data for binary display in another plane, and storing data for color display in the other planes, and
the palette table is configured to be capable of selecting one of the color data for the binary display and the color data for the color display, according to a value of the data for identification.

19. A display method according to claim 15, wherein a video memory is comprised of the planes.

20. A display method according to claim 15, wherein the display unit is an LCD.
